(19) United States
(12) Patent Application Publication
(10) Pub. No.: US 2026/0249219 A1
(43) Pub. Date: Aug. 27, 2026

(54) INSERTABLE MEDIA CLEANER FOR HVAC DUCT

(71) Applicant: Vibrant Building Technologies, Norwalk, CT (US)

(72) Inventors: Ryan Anderson FLETCHER, Redding, CT (US); Nicholas P. WITTE, West Lebanon, NH (US); Stephen B. HOROWITZ, North Bennington, VT (US); Gavin MCCAUL, New York, NY (US)

(21) Appl. No.: 19/060,597

(22) Filed: Feb. 21, 2025

(51) Int. Cl. B01D 46/00; F24F 8/90; F24F 13/28

(52) U.S. Cl. CPC B01D 46/0006; B01D 46/0028; F24F 8/90; F24F 13/28; B01D 2265/025; B01D 2279/50; B01D 2279/65

(57) ABSTRACT

Embodiments herein describe a heating, ventilation, and air conditioning (HVAC) system including a duct with a single opening, the duct configured to receive an HVAC filter assembly including an access assembly and a filter frame guidance assembly secured to the access assembly, the filter frame guidance assembly including a U-shaped frame having a first panel with a top bracket, a second panel with a top bracket, and a third panel with a top bracket. Each of the top brackets has a triangular shape. Each of the top brackets has an angled surface disposed at (e.g. 45 degrees) with respect to a top surface of a filter resting within the filter frame guidance assembly. A filter is configured to be received between the top brackets and bottom brackets of the U-shaped frame. An angled surface of the top brackets is configured to secure a light emitting diode array.

### TECHNICAL FIELD

Examples of the present disclosure generally relate to an insertable media cleaner for a heating, ventilation, and air conditioning (HVAC) duct.

### BACKGROUND

Existing heating, ventilation, and air conditioning (HVAC) systems with air filtration are commonly used to regulate indoor air quality by controlling temperature, humidity, and airborne contaminants. These systems typically include a central air handler that circulates conditioned air through ductwork, with filtration mechanisms such as mechanical filters (e.g., HEPA or MERV-rated filters) to capture particulates, as well as activated carbon filters for odor and chemical removal. Despite these advancements, traditional HVAC filtration relies on passive air movement, requiring contaminants to reach the filter before being removed, which may limit overall effectiveness in capturing airborne pollutants in real time.

To enhance filtration efficiency, modern HVAC systems increasingly incorporate smart controls and sensor-driven air quality monitoring. These systems utilize real-time data from particulate, volatile organic compound (VOC), and carbon dioxide (CO₂) sensors to adjust airflow, filtration rates, or activate supplemental purification methods. However, existing systems often face challenges related to filter degradation, pressure drops, and the need for frequent maintenance, highlighting the need for improved air filtration technologies that offer more proactive and adaptive pollutant removal strategies.

Improvement of indoor air quality in residential spaces is often achieved through addition of a media cleaner into the HVAC return path. This media cleaner typically includes high efficiency mechanical filtration. Installation into an existing HVAC system involves complete cutting and removal of a section of HVAC return ducting, insertion of the media cleaner, and connection and sealing to the existing ducting, leading to higher labor cost and time than desired.

Separately, disinfection of air to kill various airborne microbes, such as bacteria, viruses, and fungi, is typically achieved through ultraviolet-C (UVC) illumination or ionization of the air. Ionization and certain wavelength bands of UVC can produce unwanted and hazardous ozone, which need to be removed via gas-phase absorption to reduce potential harm. However, UVC illumination in the 260-270 nm range has been shown to be effective at disinfection without generating detectable levels of ozone. This can be achieved through use of recently available UVC LEDs that emit in this wavelength range. Further, the use of LEDs avoids the potential hazards of mercury-based bulbs that were historically used to generate UVC light.

Current implementations of UVC disinfection in HVAC systems either focus on surface disinfection of problem areas, such as cooling coils, where mold and bacteria are most likely to grow, or they focus on volume disinfection of the cycled air. For surface disinfection, long exposure times are easily obtained, and thus low intensity UVC sources are sufficient. However, for volume disinfection, higher intensity illumination is needed to achieve a sufficient dose in the short period of time that a section of air passes across the illuminated zone. To reach a sufficient dose, e.g., D90 (where 90% of microbes are killed or deactivated), the UVC source should be selected, designed, and placed appropriately for optimal coverage.

Existing UVC disinfection systems for HVAC employ a standalone module that is installed into the ductwork, separately from other HVAC and filtration components. This leads to additional labor cost and time, as well as more overall material cost, as the standalone module needs its own enclosure, power supply, and fixturing.

In contrast to the current, existing media cleaner systems and approaches, herein are described innovations that reduce installation labor cost and time and reduce material cost for an HVAC media cleaner.

### SUMMARY

One example described herein is an HVAC filter assembly including an access assembly and a filter frame guidance assembly secured to the access assembly, the filter frame guidance assembly including a U-shaped frame having a first panel with a top bracket, a second panel with a top bracket, and a third panel with a top bracket.

One example described herein is an HVAC system including a duct with a single opening, the duct configured to receive an HVAC filter assembly including an access assembly and a filter frame guidance assembly secured to the access assembly, the filter frame guidance assembly including a U-shaped frame having a first panel with a top bracket, a second panel with a top bracket, and a third panel with a top bracket.

One example described herein is a method including simulating a particle to traverse an illuminated space, capturing an intensity at each point in a trajectory of the particle, estimate a total exposure dose by integrating the intensity along the trajectory, comparing the estimated total exposure dose to a target disinfection dose, and creating a two-dimensional (2D) map of a total dose at each starting point across a duct of an HVAC system, the duct configured to receive an HVAC filter assembly.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates a perspective view of an insertable media cleaner for a heating, ventilation, and air conditioning (HVAC) duct, according to an example.

FIG. 1B illustrates a perspective view of the insertable media cleaner with a filter inserted therein, according to an example.

FIG. 1C illustrates a front view of the insertable media cleaner with the filter inserted therein and the front access door removed, according to an example.

FIG. 2A illustrates the insertable media cleaner secured to a return duct of the HVAC system with the filter access door in an open position, according to an example.

FIG. 2B illustrates the filter being inserted through the filter access door of the insertable media cleaner secured to the return duct of the HVAC system, according to an example.

FIG. 2C illustrates the filter fully inserted through the filter access door of the insertable media cleaner secured to the return duct of the HVAC system, according to an example.

FIG. 2D illustrates the insertable media cleaner secured to the return duct of the HVAC system with the access door in an open position, according to an example.

FIG. 3A illustrates a connection mechanism for connecting the filter track guidance system to the insertable media cleaner, according to an example.

FIG. 3B illustrates connecting the filter track guidance system to the insertable media cleaner via the connection mechanism, according to an example.

FIG. 4 illustrates an exploded view of the insertable media cleaner, according to an example.

FIG. 5A illustrates a front portion of the insertable media cleaner mounted to the return duct of an HVAC system, according to an example.

FIG. 5B illustrates the frame portion of the insertable media cleaner with the filter track guidance system, according to an example.

FIG. 5C illustrates a top portion of the filter track guidance system including an ultraviolet-C (UVC) light emitting diode (LED) array, according to an example.

FIG. 5D illustrates a perspective of the filter track guidance system being placed within the return duct of the HVAC system, according to an example.

FIG. 6A illustrates a side view of the UVC LED array placed adjacent the filter, according to an example.

FIG. 6B illustrates a top view of the filter and the UVC LED array placed adjacent the filter, according to an example.

FIG. 6C illustrates the UVC LED array placed adjacent the filter, according to an example.

FIG. 7A illustrates the bracket supporting the UVC LED array, the bracket attached to a sidewall of the frame, according to an example.

FIG. 7B illustrates a side view of the bracket supporting the UVC LED array, the bracket attached to the sidewall of the frame, according to an example.

FIG. 7C illustrates a top connector and bottom connector secured to the filter track guidance system, according to an example.

FIG. 8 illustrates a method for determining an optimal placement of the UVC LED array to maximize overall disinfection effectiveness, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Air filtration systems in heating, ventilation, and air conditioning (HVAC) improve indoor air quality by removing airborne contaminants such as dust, pollen, mold spores, bacteria, and volatile organic compounds (VOCs). These systems help create a healthier indoor environment by reducing allergens, odors, and harmful particulates that can affect respiratory health. Additionally, air filtration protects HVAC components from dust buildup, enhancing system efficiency, and prolonging equipment lifespan.

HVAC air filtration systems typically consist of mechanical filters (such as HEPA or MERV-rated filters), activated carbon filters for odor and chemical absorption, and advanced technologies like ultraviolet-C (UVC) light or electrostatic precipitators for microbial neutralization. HVAC air filtration systems are installed within the HVAC ductwork or air handler unit, positioned in return air intakes or supply vents to capture contaminants before air is circulated throughout a building. Some systems integrate with smart sensors and automated controls to adjust filtration levels based on real-time air quality data. Proper installation and maintenance are essential to ensure optimal performance, prevent pressure drops, and maintain efficient airflow within the HVAC system.

Existing HVAC filtration systems, while effective in removing airborne contaminants, have several limitations that impact their overall efficiency and maintenance requirements. Such limitations include airflow resistance and pressure drop. High-efficiency filters, such as HEPA or high-MERV filters, create significant airflow resistance, increasing the workload on HVAC blowers and potentially reducing system efficiency. This can lead to higher energy consumption and premature wear on HVAC components. Another limitation includes filter bypass issues. Poorly fitted or improperly installed filters can allow unfiltered air to bypass the filtration system, reducing overall air quality. Traditional filter slots or frames may not always provide a perfect seal, leading to leaks. Another limitation includes maintenance challenges. Filters need regular replacement to maintain efficiency, but access to them can be difficult, especially in centralized or hard-to-reach HVAC systems. Neglecting filter maintenance can lead to clogged filters, reduced airflow, and system inefficiencies. A further limitation includes size and installation constraints. Many HVAC systems have predefined filter slots that limit the size and type of filters that can be used. Upgrading filtration often involves system modifications, increasing installation complexity and cost.

These limitations highlight the need for improved filtration systems. The examples herein alleviate such issues by presenting an insertable media cleaner with a UVC light emitting diode (LED) array. The proposed approach involves modifying the return duct of an HVAC system by cutting an opening on a single side, rather than all four sides, to create a rectangular window. A frame is then installed inside the return duct through this opening, serving as a secure housing for an air filter. The filter is inserted into the frame via a guided track system that ensures proper alignment and sealing, enhancing filtration efficiency while simplifying filter replacement.

The examples described herein reduce installation labor cost and time and reduce material cost for an HVAC media cleaner by enabling installation into an existing HVAC return duct without removal of a section of ducting. Instead, the examples enable insertion of the media cleaner into an opening cut into only one side of the duct, leveraging the existing duct for enclosure of the remaining three sides.

In contrast to current UVC air volume disinfection systems, the examples reduce installation labor cost and time and reduce material cost for a UVC air volume disinfection module by integrating this module into the media cleaner and designing the quantity, orientation and placement of UVC emitters to provide optimal coverage for sufficient disinfection dosage across a maximal percent of return air. Integrating this functionality into the media cleaner eliminates the labor cost and time associated with a standalone module, and reduces the overall material cost of the system, by leveraging existing media cleaner structure and fixturing, as well as power and control systems.

Additionally, a method is proposed for determination of illumination intensity and total exposure dosage at each point in space within the illuminated region of the return duct with a known air velocity profile.

This approach offers several benefits over traditional filter installations. By limiting duct modifications to a single side, structural integrity is maintained while reducing installation complexity and potential leakage points. The guided filter track ensures that the filter remains properly seated within the frame, preventing air bypass and maximizing contaminant capture. Additionally, the sliding mechanism facilitates easy filter replacement without requiring full access to the entire duct, making maintenance more convenient and less intrusive. This approach also allows for retrofitting in existing HVAC systems with minimal modifications, providing an efficient and user-friendly solution for improving indoor air quality.

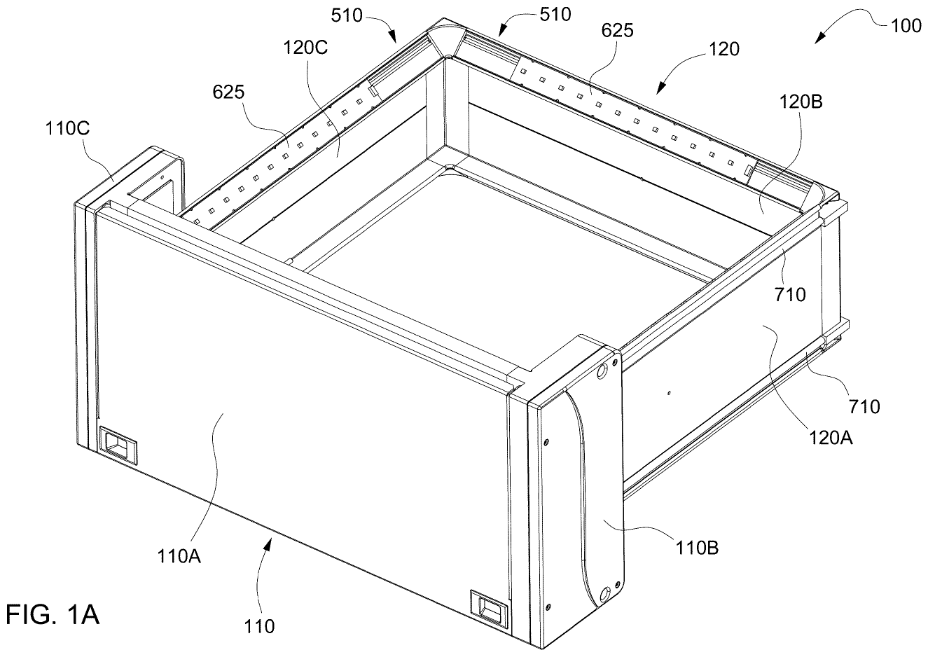

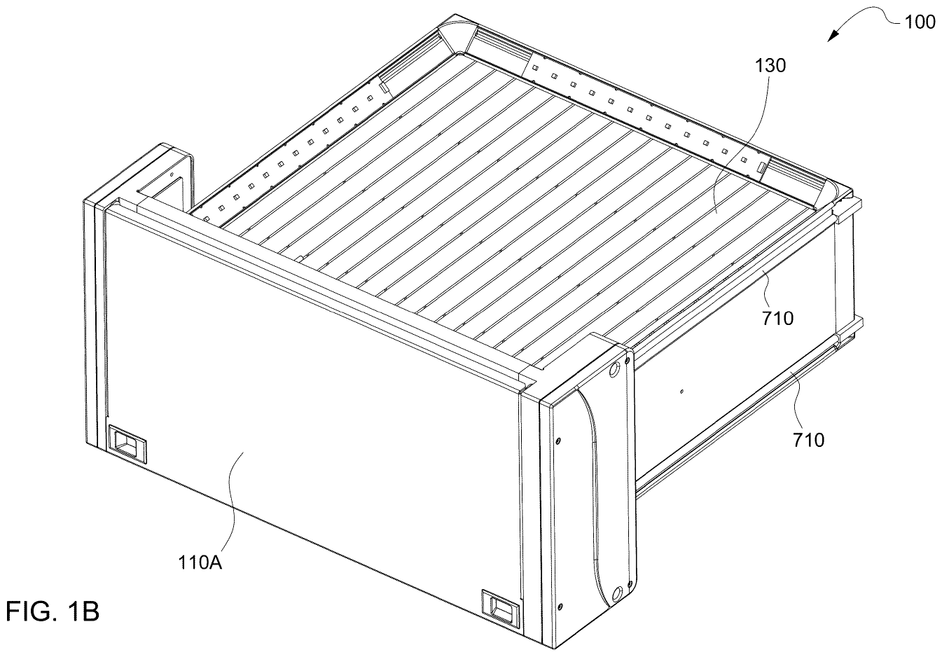

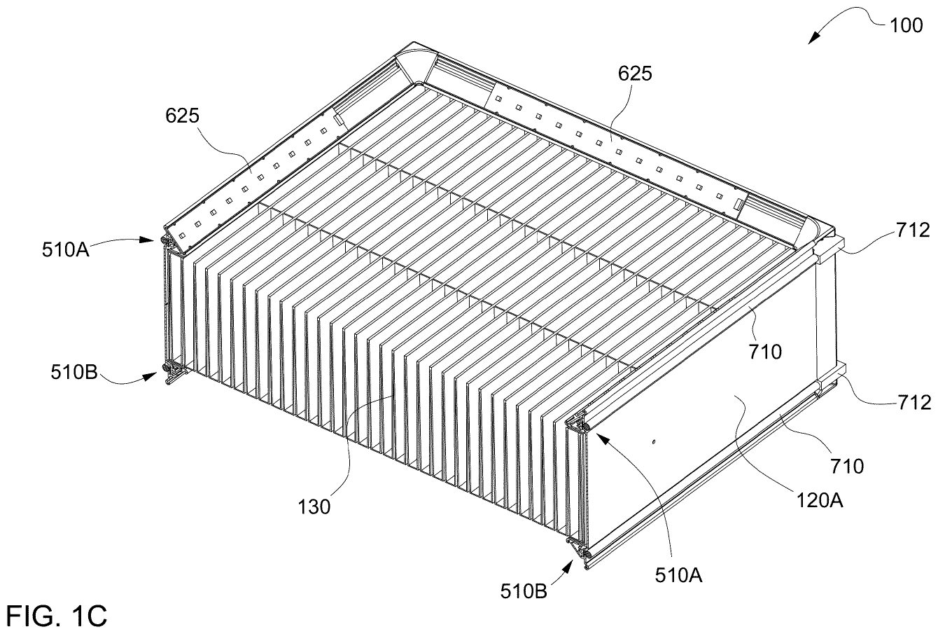

FIG. 1A illustrates a perspective view of an insertable media cleaner for a heating, ventilation, and air conditioning (HVAC) duct, according to an example.

The insertable media cleaner 100 includes a first portion and a second portion. The insertable media cleaner 100 may be referred to as a filter casing or filter case or filter housing or filter assembly or HVAC filter assembly. The first portion is an access portion 110 and the second portion is a frame portion 120. The access portion 110 may be referred to as an access assembly. The frame portion 120 may be referred to as a frame or filter frame or cleaner frame or guidance frame or a filter frame guidance system/assembly.

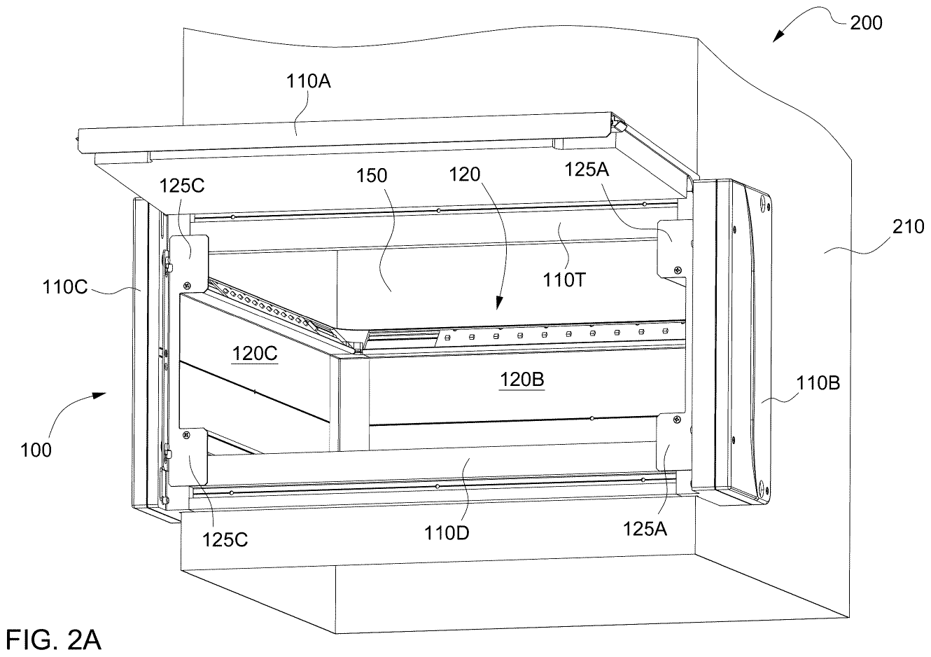

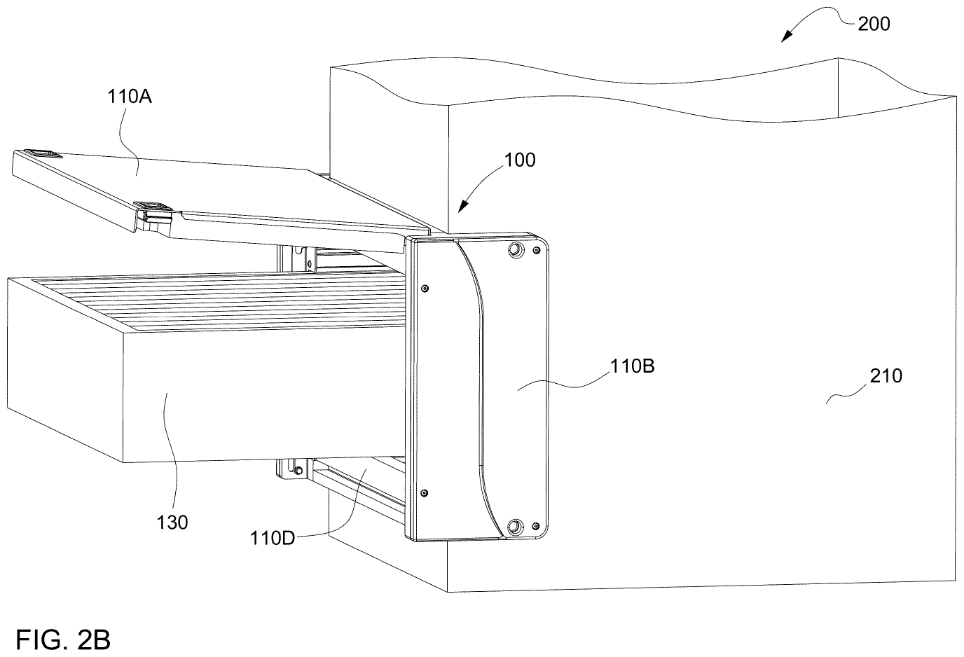

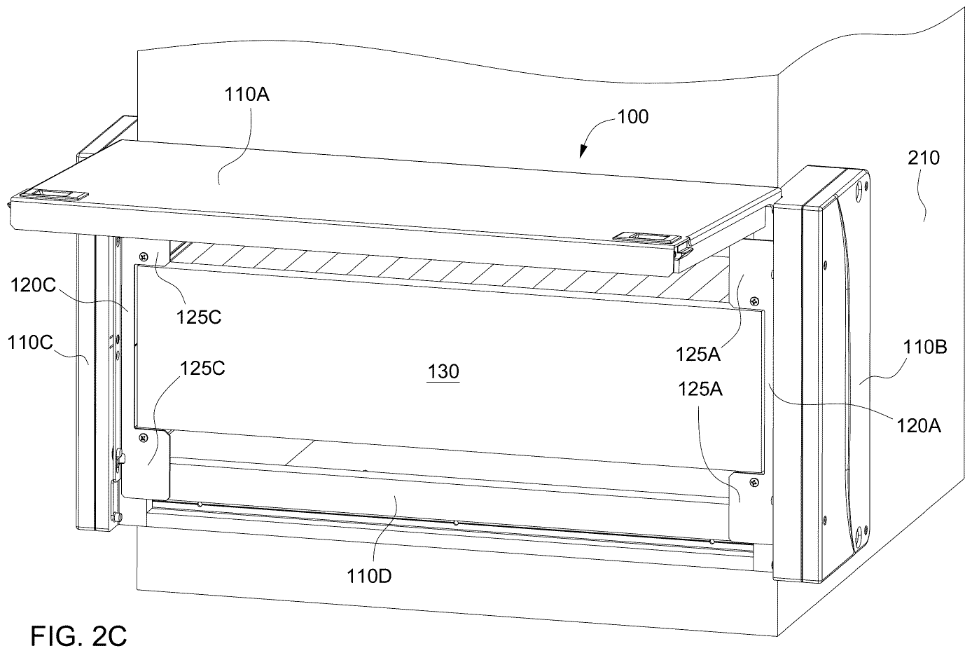

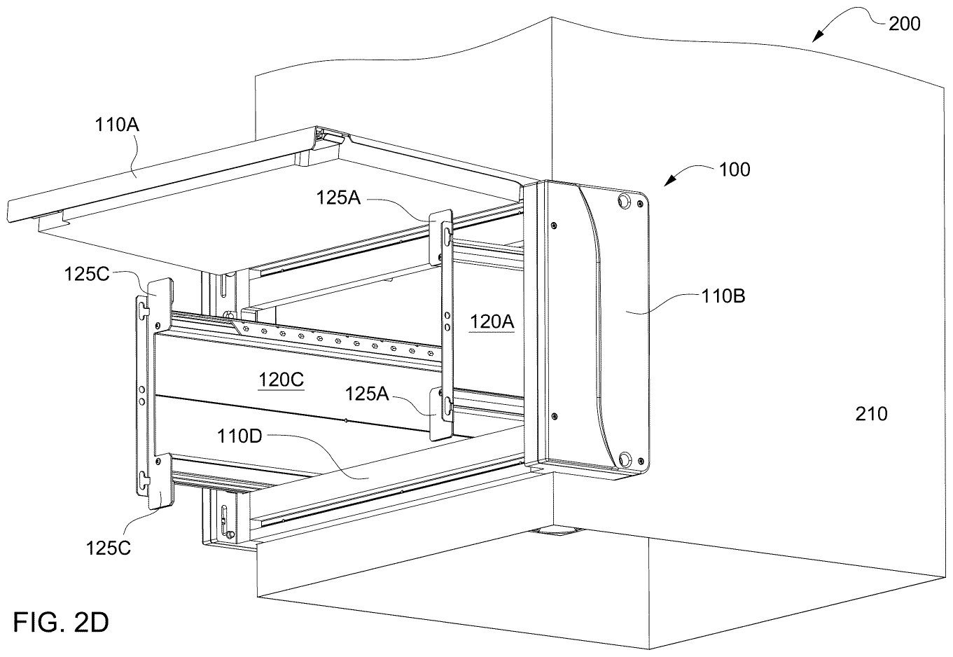

The access portion 110 includes an access door 110A, a first side section 110B, a second side section 110C, a bottom side section 100D (FIG. 2A), and a top side section 110T (FIG. 2A). The sections may be referred to as structures or interfaces.

The frame portion 120 includes a first side wall 120A, a second side wall 120C, and a back wall 120B. The first side wall 120A, the second side wall 120C, and the back wall 120B may be referred to as panels. A top portion of the first side wall 120A includes a bracket 510, a top portion of the second side wall 120C includes a bracket 510, and a top portion of the back wall 120B includes a bracket 510. Each bracket 510 is configured to accommodate a UVC LED array 625. In one example, three UVC LED arrays 625 are provided. In other examples, more or less UVC LED arrays may be provided. The brackets 510 and the UVC LED array 625 will be described in more detail below.

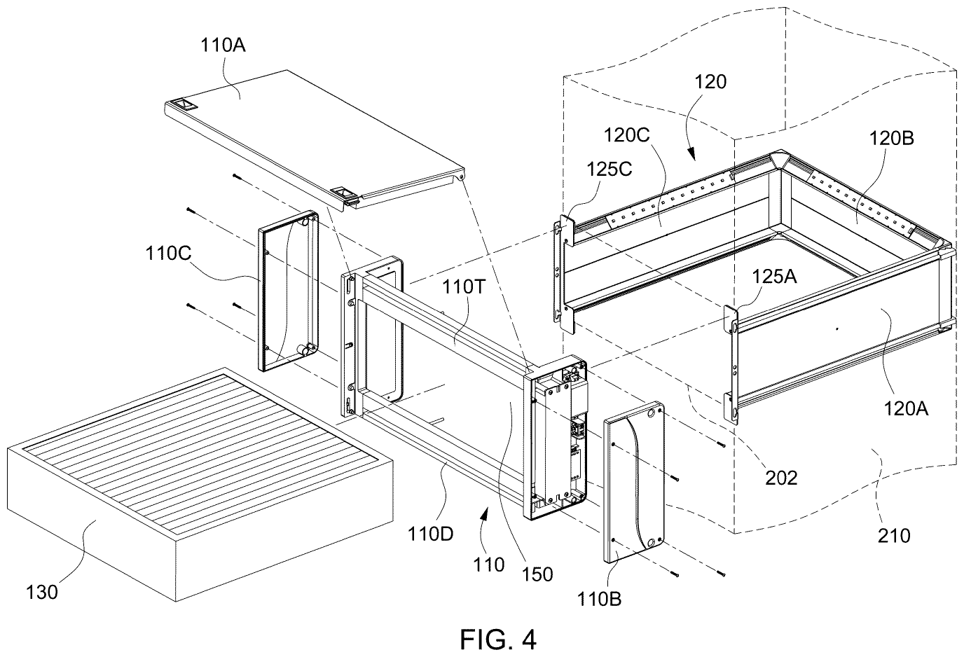

The insertable media cleaner 100 is configured to receive a filter 130 (FIG. 1B). The insertable media cleaner 100 is configured to be mounted or secured within a duct of an HVAC system (FIGS. 2A-2C and 4). The first side wall 120A, the second side wall 120C, and the back wall 120B are secured to the interior of the return duct 210 (FIG. 2A) of the HVAC system. The first side wall 120A includes connectors 710 and the second side wall 120C includes connectors 710. The connectors 710 extend a horizontal length of the outer surface of the first side wall 120A and the second side wall 120C. The connectors 710 may be linear connections defining a substantially circular shape. The duct 210 may be a return duct. However, the duct 210 may also be a supply duct. The duct 210 may be any duct of the HVAC system 200 (FIG. 2A).

FIG. 1B illustrates a perspective view of the insertable media cleaner with a filter inserted therein, according to an example.

The insertable media cleaner 100 is configured to receive a filter 130. The filter 130 is received through the access door 110A of the access portion 110. The filter 130 fits seamlessly within the frame portion 120, which is securely fastened to the interior of the return duct 210 (FIG. 2A) of the HVAC system. The filter 130 extends to the back wall 120B of the frame portion 120. The filter 130 is configured to be sized according to the dimensions of the opening of the return duct of the HVAC system.

In one example, the filter 130 may be a filter assembly that is not a single rigid structure, but rather a series of filter supports that collectively hold and stabilize filtration media. The filter supports may be strategically spaced to hold the filtration media evenly, preventing warping or bending due to air pressure. The filter supports create a firm seal between the filter media and the surrounding frame, ensuring that unfiltered air does not leak around the filter. The filter supports interlock with the triangular top and bottom brackets, reinforcing the filter's alignment and stability within the return duct 210. The brackets 510 and filter supports can work together to guide the filter smoothly into position. The filter media remains taunt across the filter supports, ensuring consistent filtration performance. The series of supports may prevent the filter from collapsing or deforming, even under high airflow conditions. The filter supports help maintain uniform spacing within the filter media. Further, the filter supports allow the filter to slide in and out effortlessly, making replacements quicker and more reliable.

FIG. 1C illustrates a front view of the insertable media cleaner with the filter inserted therein and the front access door removed, according to an example.

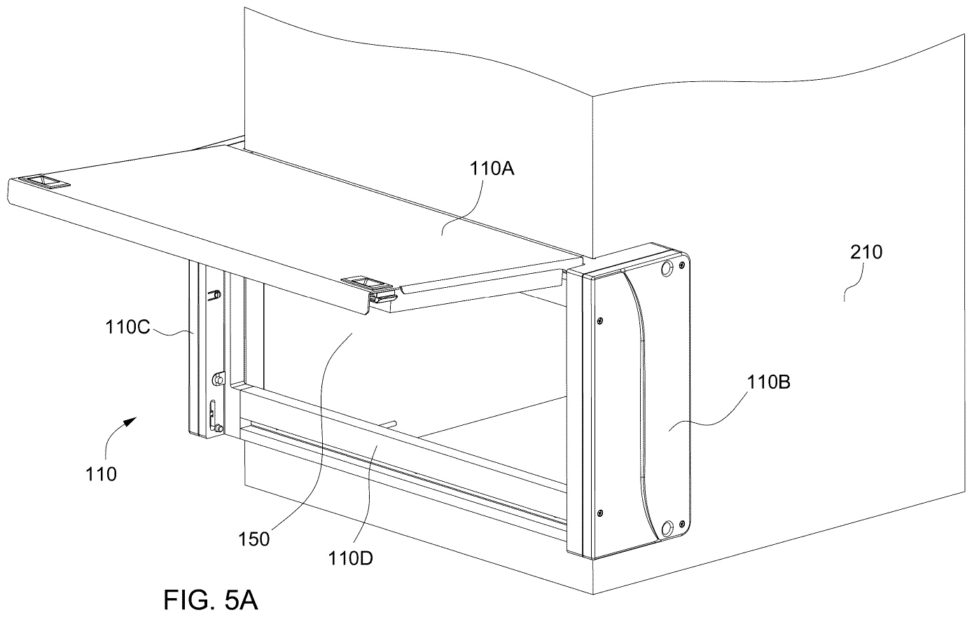

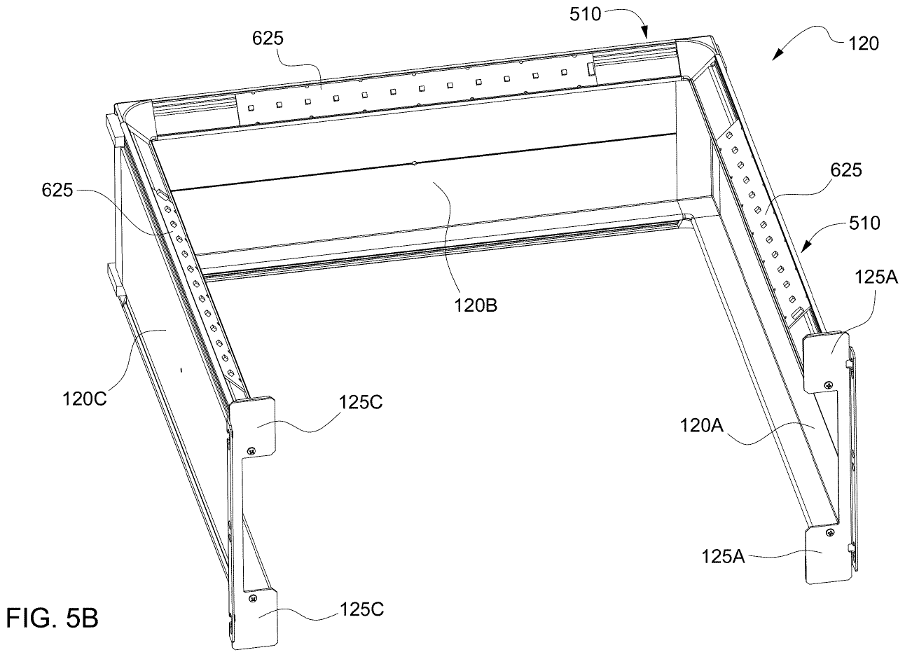

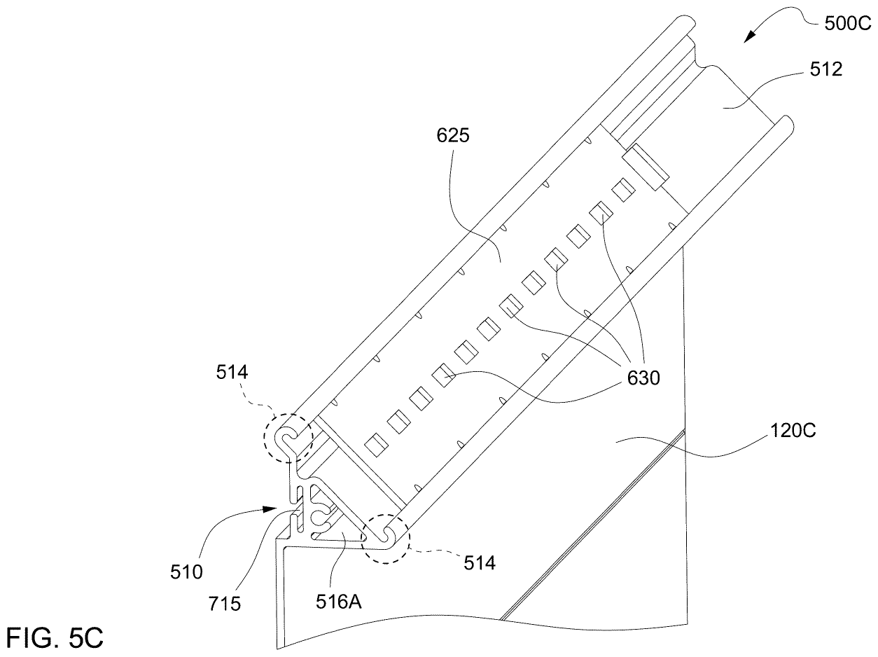

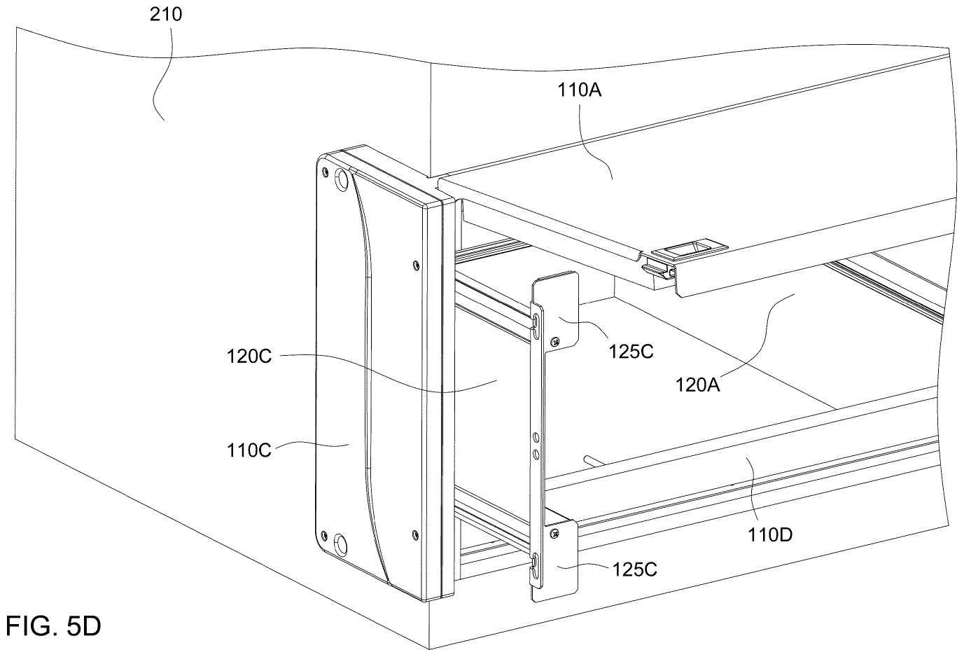

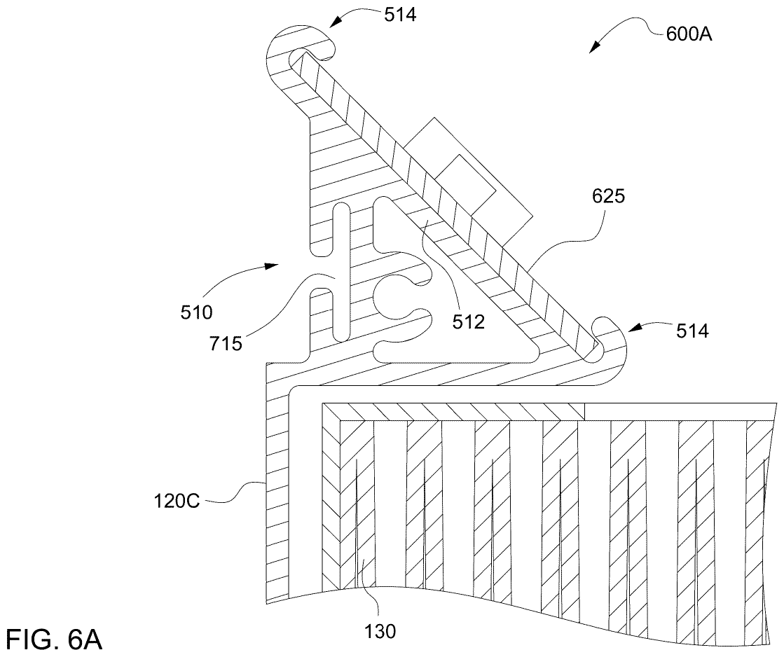

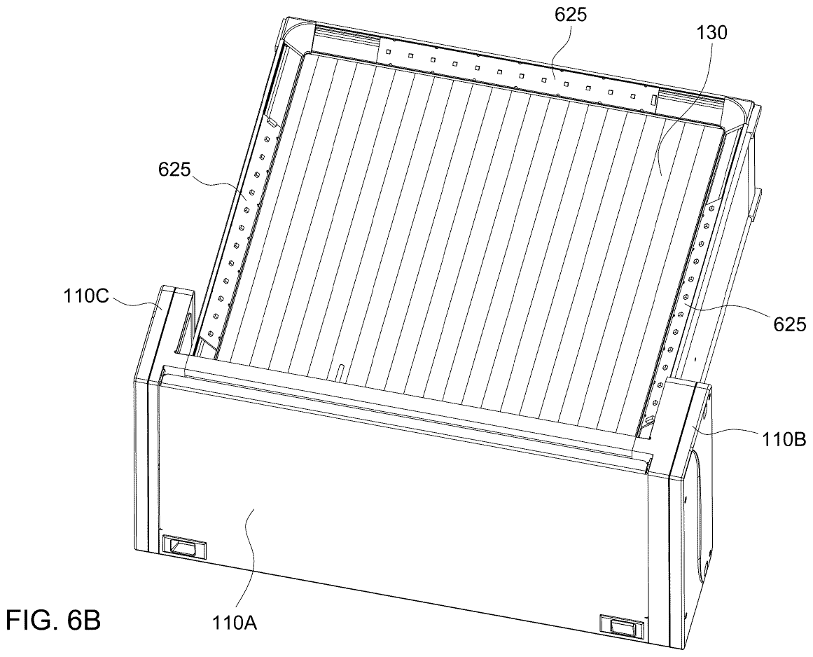

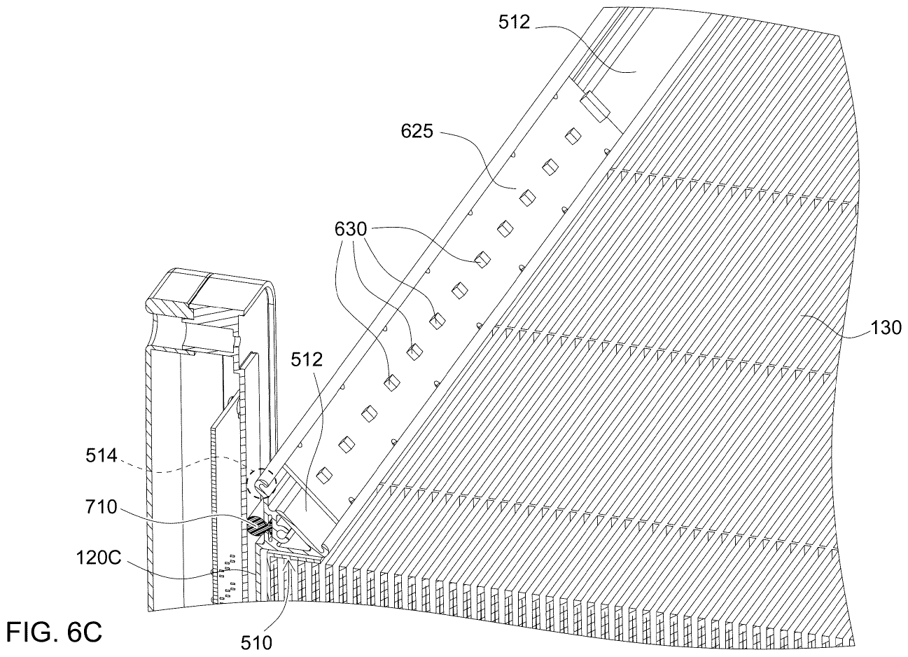

The front view, with the access door 110A removed, clearly depicts the filter 130 secured within the insertable media cleaner 100. The UVC LED arrays 625 are also shown secured to the brackets 510 of the first side wall 120A, the second side wall 120C, and the back wall 120B. Further, the first side wall 120A has an upper bracket 510A and a lower bracket 510B. Similarly, the second side wall 120C has an upper bracket 510A and a lower bracket 510B. The upper bracket 510A and the lower bracket 510B are configured to receive connectors 710. The first side wall 120A includes connectors 710 and the second side wall 120C includes connectors 710. The connectors 710 extend a horizontal length of the surface of the outer surface of first side wall 120A and the second side wall 120C. The connectors 710 may be linear connections defining a substantially circular shape. In one example, there are two connectors 710. The two connectors 710 are parallel to each other. Each connector 710 extends to a corresponding connector receptacle 712 disposed at a top portion and a bottom portion of the back wall 120B. The connectors 710 cooperate with a channel 715 (FIGS. 5C, 6A) defined by the upper brackets 510A and the lower brackets 510B.

FIG. 2A illustrates the insertable media cleaner secured to a return duct of the HVAC system with the filter access door in an open position, according to an example.

The HVAC system 200 depicts the insertable media cleaner 100 secured to a return duct 210. The access door 110A is in an open position to reveal inlet or opening 150. When the access door 110A is in an open position, the frame portion 120 is visible. In this view, the back wall 120B and the second side wall 120C are visible. The front portion of the first side wall 120A defines two front plate faces 125A and the front portion of the second side wall 120C defines two front plate faces 125C. The front plate faces 125A are disposed on the topmost and bottommost sections of the first side wall 120A. Similarly, the front plate faces 125C are disposed on the topmost and bottommost sections of the second side wall 120C. The front face plates of the side walls help guide the filter 130 within the inlet or opening 150. The filter 130 is positioned and inserted between the front face plates of the side walls.

In operation, the installation of the insertable media cleaner 100 involves modifying the return duct 210 of the HVAC system 200 by cutting an opening on a single side, rather than all four sides, to create a rectangular window 202 (FIG. 4). The access portion 110 is mounted to the opening or rectangular window 202 created on one side of the return duct 210. The access door 110A is mounted to one outer surface of the return duct 210 and the second side 100B is mounted to the opposite outer surface of the return duct 210. The frame portion 120 is installed or secured inside the return duct 210 through the opening 150, serving as a secure housing for the filter 130. The filter 130 is inserted into the frame portion 120 via a guided track system that ensures proper alignment and sealing, enhancing filtration efficiency while simplifying filter replacement.

Creating a single opening in the return duct 210 for inserting the insertable media cleaner 100 offers several benefits including simplified installation, improved airflow integrity, enhanced filtration performance, ease of maintenance, retrofitting flexibility, structural stability, and improved air quality. A single, strategically placed opening minimizes duct modifications, making it easier to integrate the filtration system without extensive structural changes. Limiting the modification to a single side of the duct reduces potential leakage points, ensuring that airflow remains properly directed through the filter for maximum efficiency. By positioning the filter within a frame with guided track, the system ensures a proper seal, preventing air bypass and optimizes contaminant capture. The single access point allows for quick and convenient filter replacement without the need to disassemble multiple duct sections, reducing downtime and maintenance effort. This approach enables the integration of high-efficiency filters into existing HVAC systems without involving major ductwork redesigns, making it a cost-effective upgrade. By only cutting one section of the return duct, the overall integrity of the duct system is preserved, reducing the risk of weakening or compromising the duct structure. The secure placement and proper alignment of the filter ensures consistent filtration, reducing dust, allergens, and pollutants from recirculating in indoor spaces.

FIG. 2B illustrates the filter being inserted through the filter access door of the insertable media cleaner secured to the return duct of the HVAC system, according to an example.

This view shows how the filter 130 is inserted into the insertable media cleaner 100, which is mounted to the return duct 210. The access door 110A is in the open position for the insertable media cleaner 100 to receive the filter 130. The filter 130 smoothly slides through the access portion 110 as it is aligned and guided by the frame portion 120.

FIG. 2C illustrates the filter fully inserted through the filter access door of the insertable media cleaner secured to the return duct of the HVAC system, according to an example.

This view shows the filter 130 fully inserted into the insertable media cleaner 100 of the return duct 210. The filter 130 is disposed between the front plate faces 125A of the first side wall 120A and the front plate faces 125C of the second side wall 120C. The filter 130 extends to the back wall 120B of the frame portion 120. The top face plates may be horizontally aligned with the top side section 110T of the access portion 110 and the bottom face plates may be horizontally aligned with the bottom side section 110D of the access portion 110.

The filter 130 seamlessly fits within the insertable media cleaner 100 (or filter assembly) to ensure optimal filtration performance and system efficiency. A snug, full coverage fit ensures that all incoming air passes through the filter 130, preventing unfiltered air from leaking around the edges and circulating contaminants back into the HVAC system 200. By covering the entire opening, the filter 130 effectively captures airborne particles, allergens, and pollutants, ensuring that the HVAC system 200 delivers cleaner air throughout the space. A well-fitted filter ensures consistent airflow distribution, preventing pressure imbalances and strain on, e.g., the HVAC blower. A properly fitted filter slides smoothly in and out of the guided track within the filter assembly, making replacements quick and hassle-free without involving adjustments or repositioning.

FIG. 2D illustrates the insertable media cleaner secured to the return duct of the HVAC system with the access door in an open position, according to an example.

The HVAC system 200 includes the return duct 210. The insertable media cleaner 100 is secured to the return duct 210. The access portion 110 is secured to the rectangular window 202 (FIG. 4) created in the return duct 210. The ideal location of the rectangular window 202 (or rectangular opening or rectangular cut-out) in the return duct 210 for inserting the filter 130 may depend on airflow dynamics, accessibility, and system efficiency. In one example, the rectangular window 202 may be created in close proximity to the air handler/furnace. This ensures that all return air passes through the filter 130 before reaching the HVAC components, protecting coils, blowers, and other parts from dust buildup and contamination. In another example, the rectangular window 202 may be created on a straight duct section, rather than elbows or bends to ensure that airflow is more uniform in straight sections, allowing the filter 130 to function efficiently without uneven loading. In another example, the rectangular window 202 may be created to allow accessibility to easy maintenance. The opening can be created at a location that allows for easy filter replacement without the need for excessive disassembly. This reduces maintenance time and encourages regular filter changes, which improves indoor air quality. In another example, the rectangular window 202 may be created such that there is sufficient space for filter installation. A section of the air duct is chosen with enough clearance to accommodate the filter size and sliding mechanism, as a tight space may make it difficult to slide the filter in and out, leading to improper alignment or air bypass.

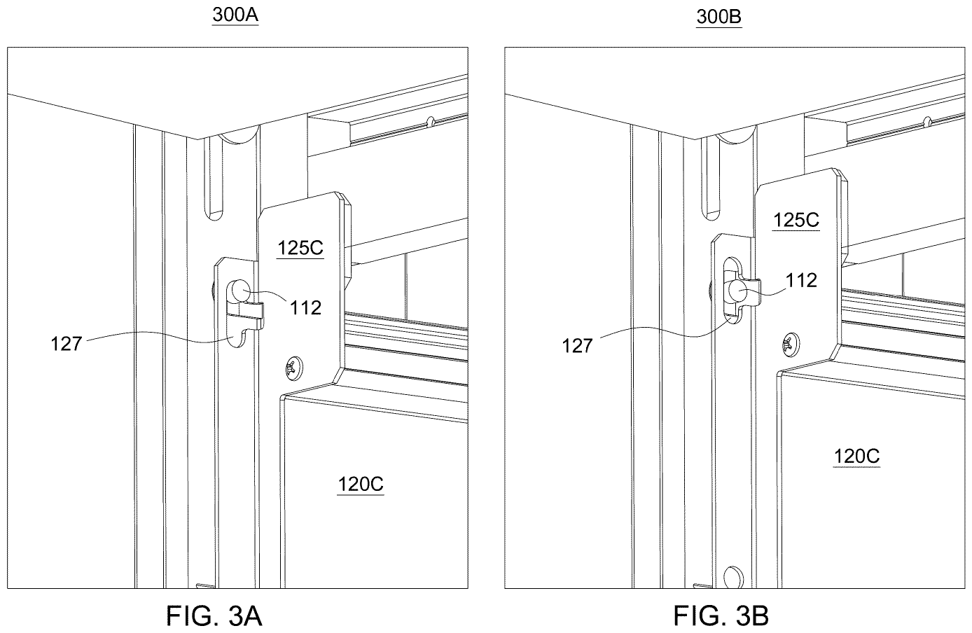

FIG. 3A illustrates a connection mechanism for connecting the filter track guidance system to the insertable media cleaner, according to an example.

The sidewalls of the access portion 110 may include tabs 112 that are configured to be received by an aperture 127 of the frame portion 120. In one example, the second side section 110C of the access portion 110 is shown to include a tab 112. The tab 112 is configured to cooperate with the aperture 127 of the second side wall 120C of the frame portion 120. The aperture 127 may be formed adjacent the front plate faces 125C. The tab 112 may be referred to as a protrusion. Multiple tabs 112 may be used. The tabs 112 may have different geometric shapes.

FIG. 3B illustrates connecting the filter track guidance system to the insertable media cleaner via the connection mechanism, according to an example.

In this view, the tab 112 has been tightly secured to the top portion of the aperture 127 of the second side wall 120C of the frame portion 120. As such, this is one example for attaching or securing the frame portion 120 to the access portion 110. The access portion 110 and the frame portions 120 collectively form or define the insertable media cleaner 100 (or filter assembly).

In other examples, other connection mechanisms may be employed to fixedly attach or secure the frame portion 120 to the access portion 110. For example, a snap-fit connection may be employed. The access portion 110 may include flexible tabs or protrusions that snap into corresponding slots or apertures of the frame portion 120. In another example, screw or bolt fasteners may be employed. The frame portion 120 may be attached to the access portion 110 using screws, bolts, or rivets through, e.g., pre-drilled slots. This creates a strong, vibration resistant connection and may be ideal for permanent installations. In another example, a hook and latch or clip mechanism may be employed. The access portion 110 may include hooks or clips that latch onto the corresponding slots of the frame portion 120. In other examples, adhesive or sealing bonding may be employed. As such, the access portion 110 may be secured to the frame portion 120 using any number of techniques. The examples are not limited to any technique.

FIG. 4 illustrates an exploded view of the insertable media cleaner, according to an example.

The exploded view 400 shows the access portion 110 and the frame portion 120. The frame portion 120 is securedly fixed to the interior walls or surfaces of the return duct 210. The frame portion 120 includes three panels, that is, the first side wall 120A, the second side wall 120C, and the back wall 120B. The first side wall 120A, the second side wall 120C, and the back wall 120B form a U-shaped configuration. The access portion 110 includes the access door 110A, the first side section 110B, the second side section 110C, the bottom side section 100D, and the top side section 110T. The access door 110A is shown in the open position, where it receives the filter 130. The return duct 210 includes the rectangular window 202 (cut out from a single surface of the return duct 210) for receiving the insertable media cleaner 100 (or filter assembly).

An insertable filtration system or assembly within an HVAC duct, which allows users to create an opening at a desired point, offers several advantages in terms of flexibility, efficiency, and ease of maintenance. By enabling installation at any chosen section of the duct, the filtration system provides adaptability to different HVAC configurations, making it suitable for both new and retrofit applications. Users can strategically place the filter system or assembly where airflow dynamics are most favorable, optimizing filtration performance without the need for extensive ductwork modifications.

This approach improves accessibility, as the filter system or assembly can be inserted and removed through a designated opening, eliminating the need to access the entire duct system. The guided track ensures proper alignment, preventing air bypass and maintaining effective contaminant removal. Additionally, by sectioning the filtration area, users can introduce multi-stage filtration, such as pre-filters for larger particles and finer filters for allergens and VOCs, without overhauling the entire HVAC system. This approach enhances air quality, reduces maintenance time, and allows for cost-effective upgrades, making it an ideal solution for residential, commercial, and industrial HVAC applications.

FIG. 5A illustrates a front portion of the insertable media cleaner mounted to the return duct of an HVAC system, according to an example.

The front portion is the access portion 110 that is secured to the rectangular window 202 created in the return duct 210. The access portion 110 includes the access door 110A configured to be opened to receive the filter 130. The access portion 110 is secured to the sides of the return duct 210 using the first side section 110B and the second side section 110C. The access portion 110 is secured to the front face of the return duct 210 using the bottom side section 100D and the top side section 110T. This is a simplified view showing the access portion 110 attached or secured to the front of the return duct 210 (or to a single opening of the return duct 210).

FIG. 5B illustrates the frame portion of the insertable media cleaner with the filter track guidance system, according to an example.

The frame portion 120 is securedly fixed to the access portion 110. The frame portion 120 includes the first side wall 120A, the second side wall 120C, and the back wall 120B that collectively form a U-shaped configuration. The first side wall 120A defines two front plate faces 125A and the front portion of the second side wall 120C defines two front plate faces 125C. The front plate faces 125A are disposed on the topmost and bottommost sections of the first side wall 120A. Similarly, the front plate faces 125C are disposed on the topmost and bottommost sections of the second side wall 120C. The front face plates of the side walls help guide and align the filter 130 within the inlet or opening 150. The filter 130 is positioned between the front face plates of the side walls.

Additionally, the UVC LED arrays 625 are shown. In one example, there are three UVC LED arrays 625. In other examples, more or less UVC LED arrays may be provided. Each UVC LED array 625 is secured to corresponding top portions of the first side wall 120A, the second side wall 120C, and the back wall 120B. For example, the first side wall 120A includes a bracket 510 (FIG. 5C) formed on a topmost portion thereof. The bracket 510 is configured to accommodate a UVC LED array 625. Similarly, the second side wall 120C includes a bracket 510 (FIG. 5C) formed on a topmost portion thereof. The bracket 510 is configured to accommodate a UVC LED array 625. Similarly, the back wall 120B includes a bracket 510 (FIG. 5C) formed on a topmost portion thereof. The bracket 510 is configured to accommodate a UVC LED array 625. The three UVC LED arrays 625 are thus arranged in a U-shaped configuration. The UVC LED arrays 625 do not overlap each other. The UVC LED arrays 625 are vertically offset from the central portion of the filter 130. Stated differently, the UVC LED arrays 625 are not vertically aligned with the central area of the filter 130.

A UVC LED array in an HVAC duct enhances indoor air quality by inactivating airborne pathogens, including bacteria, viruses, and mold spores, as air circulates through the system. UVC light, typically in the 200-280 nanometer (nm) wavelength range, disrupts microorganisms, preventing them from replicating and effectively neutralizing their ability to spread. Installed within the return or supply ducts, a UVC LED array provides continuous disinfection without the need for chemical treatments or physical filtration alone. Compared to traditional mercury-based UVC lamps, UVC LEDs offer benefits such as instant on/off control, longer lifespan, and lower energy consumption. Additionally, UVC LEDs generate less heat and contain less hazardous materials, making them safer for long-term use. When combined with HEPA or activated carbon filters, UVC LEDs create a multi-layered air purification system, reducing airborne pathogens while maintaining efficient airflow within the HVAC system.

In one example, the UVC LED array 625 disinfects passing air in the return duct 210 of the HVAC system 200 by illuminating the air with a sufficient illumination dosage (via intensity and exposure time) at an effective UVC wavelength, using an array of optimally placed UVC LEDs. The UVC LED array 625 provides sufficient density and coverage to achieve a disinfection-level dose of UVC band illumination over a large percentage of the passing air in the return duct 210. Microbes in the return duct 210 are exposed to a varying intensity of illumination as they travel along the return duct 210 and approach the UVC LED array 625. The total dose that each experiences is the result of the integrated intensity over their travel time. This dose is sufficiently high to deactivate or eliminate the microbes successfully and varies from one type of microbe to another. The UVC LED array 625 is physically comprised of one or more printed circuit boards including LEDs and drive electronics. The LEDs are selected to provide high optical power output in the UVC band of wavelengths (100-280 nm). A specific implementation uses three UVC LED array boards, each including, e.g., 10 LEDs, operating at a peak wavelength of 265 nm.

FIG. 5C illustrates a top portion of the filter track guidance system including an ultraviolet-C (UVC) light emitting diode (LED) array, according to an example.

The expanded view 500C shows the bracket 510. The bracket 510 has a substantially triangular-shaped configuration. The bracket 510 may define a 90 degree angle, where the 90 degree angle rests on a top surface of the second side wall 120C of the frame portion 120. The bracket 510 may include an angled surface 512 for accommodating the UVC LED array 625, which includes a plurality of LEDs 630. In one example, the plurality of LEDs 630 may be formed in a series configuration. In other examples, the plurality of LEDs 630 can be formed in other geometric configurations. As such, the UVC LED array 625 is positioned at an angle with respect to the filter 130. In one example, each of the UVC LED arrays 625 is positioned or disposed at 45 degrees with respect to the filter 130. The bracket 510 also includes a channel 715 extending a horizontal length of the bracket 510. The angled surface 512 includes hooked regions 514 for securing the UVC LED arrays 625 to the angled surface 512.

The benefits of the angled bracket design for the UVC LED arrays include optimized light distribution, minimizing shadowing, enhanced pathogen neutralization, efficient energy use, structural stability, and easy integration with the filter system or assembly. In particular, the 45 degree angle ensures the UVC light efficiently covers a larger portion of the duct interior and filter surface. The angled placement reduces shadowed areas that may otherwise block exposure, ensuring even sterilization of airborne contaminants. With the UVC light directed at both the airflow and surrounding surfaces, bacteria, viruses, and mold spores are neutralized before they recirculate into the HVAC system 200. The triangular bracket ensures that UVC irradiation is maximized, reducing wasted light directed toward unnecessary areas. The angled design also reinforces the bracket's rigidity, preventing vibrations or misalignment over time. The angled bracket configuration ensures maximum air purification efficiency while maintaining an effective and space-conscious design within the return duct 210.

The material of the bracket 510 may be heat-resistant and reflective (e.g., aluminum) to enhance UVC distribution. In other examples, airflow sensors may also be integrated to activate the UVC LEDs only when needed to improve longevity and energy efficiency.

Therefore, the angled bracket configuration and the 45-degree placement of the UVC LEDs thereon, within the return duct, are not random or arbitrary design choices. Instead, they are intentionally engineered to optimize sterilization effectiveness, airflow interaction, and energy efficiency. The 45-degree LED orientation ensures that UVC light is directed both across the airflow and onto duct surfaces, maximizing pathogen inactivation. Unlike flat or perpendicular placement, which may create shadowed regions, the angled positioning allows UVC radiation to reach more airborne particles and duct surfaces. This strategic alignment significantly improves microbial deactivation, including viruses, bacteria, and mold spores. The placement within the return duct ensures that all recirculated air passes through the UVC light path before entering the HVAC system. Since return air carries the highest concentration of airborne contaminants, treating it before it enters the main HVAC components prevents microbial growth inside coils, blower fans, and ductwork. The angled LEDs also help reduce air velocity interference, allowing sufficient exposure time for pathogens to be effectively neutralized. The angled bracket design minimizes wasted UVC output, as light is directed where it is needed instead of scattering inefficiently. The triangular bracket configuration further enhances light reflection, increasing the effective irradiance without increasing power consumption. The geometry of the angled placement also reduces the number of LEDs needed while maintaining full coverage, leading to lower operational costs and longer LED lifespan.

FIG. 5D illustrates a perspective of the filter track guidance system being placed within the return duct of the HVAC system, according to an example.

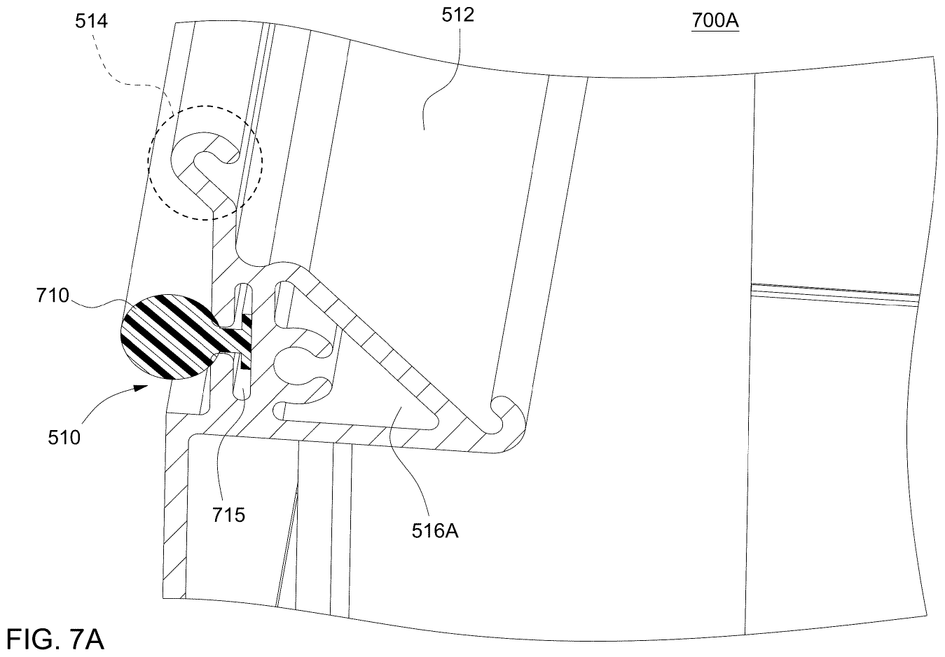

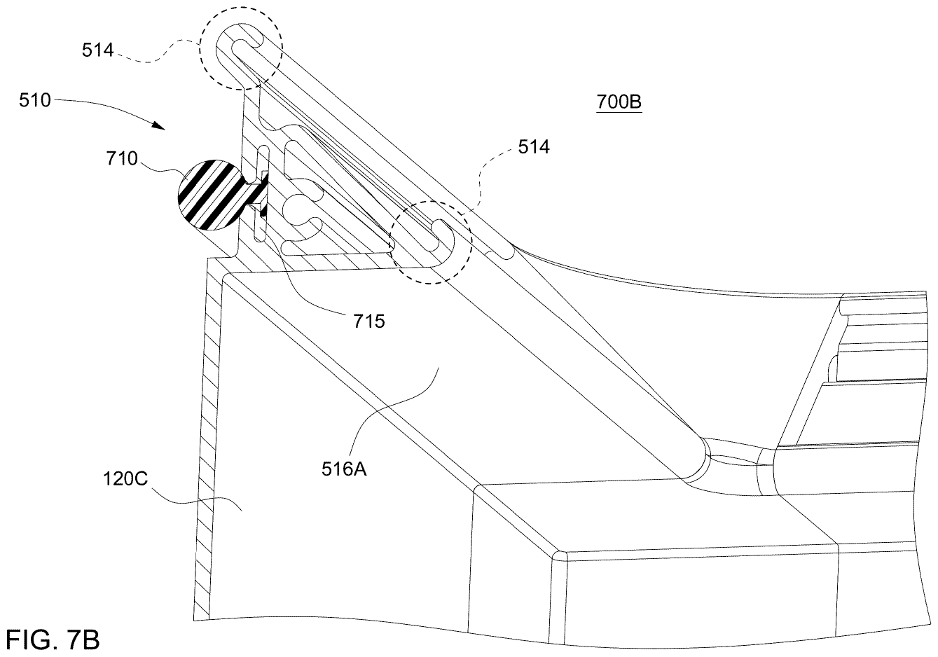

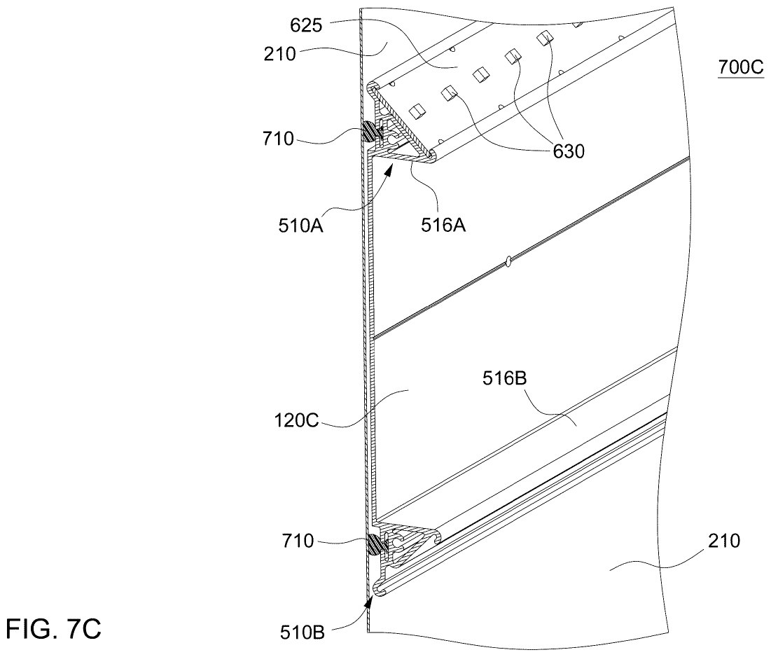

This view shows the front of the frame portion 120, as the frame portion is inserted into the opening 150 of the access portion 110. The frame portion 120 may also be referred to as the filter track guide as it assists in guiding the filter 130 within the opening 150 and through the return duct 210. The filter 130 is guided between a top triangular bracket and a bottom triangular bracket, as shown and described below with reference to FIG. 7C.

FIG. 6A illustrates a side view of the UVC LED array placed adjacent the filter, according to an example.

The system 600A shows a side view of the bracket 510 formed over a side of the filter 130. The bracket 510 is a triangular bracket with its 90 degree angle resting on the flat surface or bottom surface 516A. The bracket defines an angled top surface, that is, the angled surface 512 that accommodates the UVC LED array 625. The UVC LED array 625 is secured to the angled surface 512 by the hooked regions 514. A channel 715 is also defined by the bracket 510. The channel 715 is configured to receive the connectors 710 (FIGS. 7A and 7B) to secure the frame portion 120 to the access portion 110. The bracket 510 may extend over a portion of the filter 130. The bracket 510 may be formed at a 45 degree angle with respect to the top surface of the filter 130. As such, the UVC LED arrays 625 may be angled (e.g., at a 45 degree angle) facing the interior of the return duct 210.

Therefore, for integration with a return duct-mounted media cleaner, brackets and mounting hardware are provided, which position and align the UVC LED arrays 625 for the desired coverage. Power and illumination control are provided via connection to electronics in the insertable media cleaner 100. The LED board(s) can be placed above or below the media cleaner's filter, aimed upstream or downstream into the flow. Optimal orientation is generally at an angle relative to the flow, in order to minimize hot spots (areas of overly high does) since it wastes power that may be spread over greater area. Optimal placement of the UVC LED arrays 625 can be determined through modeling to maximize percent of cross-sectional area that achieves a high dosage (ideally D90 or higher). D90 is the level needed to achieve 90% disinfection for a particular microbe, and varies by type (bacteria, virus, or fungi), and individual species.

FIG. 6B illustrates a top view of the filter and the UVC LED array placed adjacent the filter, according to an example.

The top view shows the U-shaped configuration of the UVC LED arrays 625. The three UVC LED arrays form a U-shaped configuration over three ends of the filter 130. The UVC LED arrays 625 do not cross over the filter 130. Instead, the UVC LED arrays 625 are positioned or placed or arranged over three side surfaces of the filter 130. The UVC LED arrays 625 are not embedded within the filter 130. As such, side portions of the filter 130 extend under the UVC LED arrays 625.

FIG. 6C illustrates the UVC LED array placed adjacent the filter, according to an example.

This expanded view shows how the bracket 510 is disposed over side areas of the filter 130 such that the UVC LED array 625 is at a 45 degree angle when facing the interior of the return duct 210. The plurality of LEDs 630 are also shown in a series configuration.

FIG. 7A illustrates the bracket supporting the UVC LED array, the bracket attached to a sidewall of the frame, according to an example.

In expanded view 700A, the connector 710 is shown secured to the channel 715. The connector 710 is secured to one surface of the bracket 510. In particular, the connector 710 is secured to the side surface of the bracket 510, the surface that is vertically aligned with the side surface of the filter 130.

FIG. 7B illustrates a side view of the bracket supporting the UVC LED array, the bracket attached to the sidewall of the frame, according to an example.

In expanded view 700B, the connector 710 is shown secured to the channel 715. The flat surface or bottom surface 516A is better shown. The flat surface is the bottom surface of the triangular configuration of the bracket 510. The flat surface or bottom surface 516A extends over a side area of the filter 130. The bottom surface 516A is parallel to the top surface of the filter 130.

FIG. 7C illustrates a top connector and bottom connector secured to the filter track guidance system, according to an example.

The section 700C shows a portion of the filter track guidance system. The second side wall 120C of the frame portion 120 (or filter track guidance system) is shown. The second side wall 200C includes a top bracket 510A and a bottom bracket 510B. The top bracket 510A has a substantially triangular configuration and the bottom bracket 510B has a substantially triangular configuration. The top bracket 510A has an angled surface 512 for securing a UVC LED array 625 thereto. The top bracket has a bottom surface 516A. Similarly, the bottom bracket 510B has an angled surface 512 for, optionally, securing a UVC LED array 625 thereto. The bottom bracket has a bottom surface 516B. The bottom surface 516A of the top bracket 510A faces the bottom surface 516B of the bottom bracket 510B. A top surface of the filter 130 is configured to be placed adjacent the bottom surface 516A of the top bracket 510A and a bottom surface of the filter 130 is configured to rest on the bottom surface 516B of the bottom bracket 510B. Thus, the filter 130 is received between the top bracket 510A and the bottom bracket 510B. The filter track guidance system (or the frame portion 120) is secured to the access portion 110 via the connector 710. A first connector 710 secures the top bracket 510A to the access portion 110 and a second connector 710 secures the bottom bracket 510B to the access portion 110. The first connector 710 is parallel to the second connector 720. The first connector and the second connector may have a substantially circular shape. Other geometric shapes can also be used.

The filter guidance system is a structurally integrated assembly to position and secure the filter 130 within the return duct 210 of the HVAC system 200. The filter guidance system includes a top bracket 510A and a bottom bracket 510B, both of which are triangular in shape to provide mechanical stability and create a defined path for the filter 130 to slide into place. These brackets ensure alignment of the filter 130, preventing misalignment, bypass airflow, and loose fittings that could reduce filtration efficiency. Each bracket has a triangular cross-section, which enhances the system in multiple ways. The triangular shape provides additional rigidity, preventing bending or deformation over time due to air pressure fluctuations or repeated filter replacements. The brackets act as a guidance track, ensuring the filter glides smoothly into its designated position without obstruction.

The triangular profile prevents the filter from shifting inside the duct once inserted, ensuring consistent air filtration performance. The filter 130 slides into the track created between the top and bottom brackets 510A, 510B, ensuring straight and even placement within the return duct. The top and bottom brackets 510A, 510B align the filter in a parallel orientation to the airflow, ensuring maximum surface area exposure for effective filtration. The precise fit eliminates air gaps, preventing unfiltered air from bypassing the filter media and recirculating contaminants into the HVAC system 200. Each bracket (top or bottom) can secure a UVC LED array, allowing for customized placement based on the desired air sterilization strategy.

The UVC LEDs are angled within the triangular bracket structure to direct germicidal radiation onto surrounding airflow while minimizing hot spots.

The advantages of such structure include even UVC coverage, energy efficiency, filter longevity, and flexible configuration. The LEDs are strategically placed to cover both sides of the filter media and airflow within the duct, ensuring complete disinfection. The angled positioning of LEDs within the triangular brackets optimizes light distribution, reducing wasted radiation and ensuring that the maximum germicidal effect is achieved. UVC LED arrays can be installed on either the top bracket, bottom bracket, or both, allowing customization based on space constraints, airflow patterns, and specific sterilization requirements.

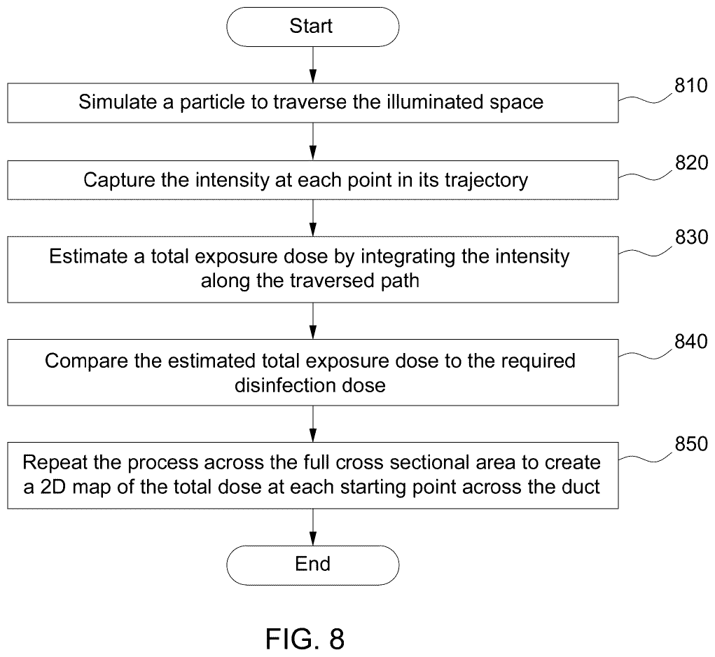

FIG. 8 illustrates a method for determining an optimal placement of the UVC LED array to maximize overall disinfection effectiveness, according to an example.

The method employs illumination modeling, which may include (depending on desired level of fidelity) ray-tracing, Gaussian beam analysis, and lambertian source modeling to estimate the overall intensity at each point in space. To find the total exposure dose, a particle is simulated to traverse the illuminated space, and the intensity at each point in its trajectory is captured. Integration of the intensity along the traversed path results in an estimate of total exposure dose. This is then compared to the required disinfection dose for potential microbes and pathogens. The process is repeated across the full cross sectional area to create a 2D map of total dose at each starting point across the duct. To maximize effectiveness, the cross-sectional area that receives a sufficient dose should be maximized. To find this optimal configuration, the placement and orientation of the UVC LED arrays 625 are adjusted and the modeling above repeated. The above modeling and optimization procedure can be applied to individual LEDs, with any kind of placement constraints, or to one or more pre-built arrays with pre-existing placement relations (e.g. a linear array of 10 mm spacing).

At 810, a particle is simulated to traverse the illuminated space.

A particle is simulated to traverse the illuminated space. In other words, the objective is to track the movement of airborne contaminants as they pass through the illuminated region of the duct. The HVAC airflow profile (velocity and turbulence characteristics) is first modeled. A set of virtual particles (representing airborne microbes) is introduced into the duct at various starting positions upstream of the UVC LEDs. Each particle follows a deterministic or probabilistic trajectory, depending on airflow conditions. The simulated particles move through the UVC-illuminated region based on the predefined airflow velocity, simulating real-world HVAC conditions.

At 820, the intensity at each point in its trajectory is captured.

The objective is to determine how much UV energy a particle is exposed to at each position along its path. UV intensity distribution is modeled. A UV intensity map is generated for the illuminated space, considering, e.g., the LED placement and orientation (e.g., 45° bracket angles) and the reflective surfaces inside the duct (which can enhance or reduce exposure). At each simulation time step, the UV intensity incident on the particle is recorded.

At 830, a total exposure dose is estimated by integrating the intensity along the traversed path.

The objective is to compute the cumulative UV exposure that each airborne microbe receives. Numerical integration techniques may be used to sum the exposure over the entire trajectory. This step accounts for particles moving at different velocities (some may have higher residence times in the UV zone than others).

At 840, the estimated total exposure dose is compared to the required disinfection dose.

The objective is to assess whether UV exposure is sufficient to neutralize pathogens. For each particle, the actual dose received is compared with the target dose. If the actual dose is less than the target dose, adjustment is needed in LED placement or intensity.

At 850, the process is repeated across the full cross sectional area to create a 2D map of the total dose at each starting point across the duct.

The objective is to visualize areas where UV exposure is insufficient or excessive, helping refine LED placement. A 2D dose map is generated by plotting starting positions of particles and their corresponding total UV exposure doses. Each grid point in the duct's cross-section represents a different injection location of a particle. A color-coded map can highlight high-dose regions (excessive exposure, potential energy waste), low-dose regions (areas where microbes may survive), and LED positions, angles, and intensity that are iteratively optimized to achieve uniform exposure across all particle trajectories.

By iterating through this process, an optimal LED placement configuration is established, ensuring uniform UV coverage across all airflow paths, sufficient exposure time for all microbes to receive a lethal dose, energy efficiency by minimizing wasted radiation, and minimal microbial survival at the duct's filter insertion point. As such, this method determines the ideal LED placement by analyzing UV intensity exposure along airflow trajectories and ensuring that airborne particles receive a sufficient germicidal dose. This systematic approach ensures that the UVC LED array placement is data-driven, rather than arbitrary, resulting in maximum disinfection effectiveness within the constraints of fixed LED count and air velocity.

In conclusion, the example single-opening filtration and UVC sterilization system for HVAC return ducts presents a highly efficient, space-conscious, and easy-to-maintain solution for improving indoor air quality. By creating a single cut-out in the return duct, a filter assembly can be securely inserted, eliminating the need for multiple access points or extensive duct modifications. This approach allows for precise air filtration and targeted sterilization, ensuring that airborne contaminants are effectively removed before recirculating through the HVAC system.

The filter assembly includes an access portion and a frame portion. The access portion serves as the interface for filter replacement and maintenance, ensuring ease of use for homeowners and facility managers. The frame portion, integrated within the return duct, functions as a filter track guidance system, ensuring the filter is positioned for optimal performance. This approach eliminates the common issue of misaligned or loosely fitted filters, which can cause air bypass and reduce filtration efficiency.

The filter track guidance system is engineered with top and bottom brackets, each triangular in shape, providing structural integrity and precise alignment for the filter. These brackets stabilize the filter media within the duct and prevent unintended shifting due to air pressure fluctuations.

A UVC LED array is integrated within the top bracket (or optionally, the bottom bracket or both). This strategic placement allows the UVC light to be directed at a precise 45-degree angle, optimizing pathogen neutralization. The UVC radiation effectively sterilizes the air passing through the filter, reducing microbial growth and extending the filter's service life. The angled orientation of the LEDs ensures that UVC energy is distributed evenly, maximizing its effectiveness without unnecessary energy waste.

Beyond its filtration and sterilization benefits, this single-opening installation approach significantly reduces installation complexity and maintenance effort. Traditional HVAC filtration systems often involve multiple cut-outs or larger modifications, increasing labor costs and potential system inefficiencies. In contrast, the example approach allows users to select an optimal section of the return duct for the single access point, providing flexibility in placement while ensuring that filtration and sterilization occur at the most effective location. The precise filter track guidance system, triangular bracket structure, and integrated UVC LED array work cohesively to enhance indoor air quality, reduce airborne contaminants, and improve overall HVAC efficiency. By using a single-opening installation, the example system offers a practical, high-performance upgrade for residential and commercial HVAC applications, ensuring cleaner, healthier air with minimal maintenance and maximum effectiveness.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Such software and/or hardware embodiments can incorporate any type of machine learning process employing a variety of different types of training data. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EEPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A heating, ventilation, and air conditioning (HVAC) filter assembly comprising:
an access assembly; and
a filter frame guidance assembly secured to the access assembly, the filter frame guidance assembly including a U-shaped frame having a first panel with a top bracket, a second panel with a top bracket, and a third panel with a top bracket.

2. The HVAC filter assembly of claim 1, wherein the access assembly is configured to receive a filter that is configured to be guided and aligned within the filter frame guidance assembly.

3. The HVAC filter assembly of claim 1, wherein the HVAC filter assembly is configured to be received within an opening of a duct of an HVAC system.

4. The HVAC filter assembly of claim 1, wherein each of the top brackets has a triangular shape.

5. The HVAC filter assembly of claim 1, wherein each of the top brackets has an angled surface disposed at an angle with respect to a top surface of a filter resting within the filter frame guidance assembly.

6. The HVAC filter assembly of claim 5, wherein the angled surface is disposed at 45 degrees with respect to the top surface of the filter.

7. The HVAC filter assembly of claim 1, wherein the first panel, the second panel, and the third panel each have a bottom bracket, wherein each of the bottom brackets has a triangular shape.

8. The HVAC filter assembly of claim 7, wherein each of the top brackets and each of the bottom brackets defines a channel extending a length of an exterior surface thereof, each channel configured to receive connectors disposed on an outer surface of the first panel and the third panel of the U-shaped frame.

9. The HVAC filter assembly of claim 7, wherein a filter is configured to be received between the top brackets and the bottom brackets of the U-shaped frame.

10. The HVAC filter assembly of claim 1, wherein an angled surface of the top brackets is configured to secure a light emitting diode (LED) array.

11. The HVAC filter assembly of claim 10, wherein the LED array is disposed at 45 degrees such that the LED array faces an interior of a duct of an HVAC system.

12. A heating, ventilation, and air conditioning (HVAC) system comprising:
a duct with a single opening, the duct configured to receive an HVAC filter assembly comprising:
an access assembly; and
a filter frame guidance assembly secured to the access assembly, the filter frame guidance assembly including a U-shaped frame having a first panel with a top bracket, a second panel with a top bracket, and a third panel with a top bracket.

13. The HVAC system of claim 12, wherein each of the top brackets has a triangular shape.

14. The HVAC system of claim 12, wherein each of the top brackets has an angled surface disposed at an angle with respect to a top surface of a filter resting within the filter frame guidance assembly.

15. The HVAC filter assembly of claim 14, wherein the angled surface is disposed at 45 degrees with respect to a top surface of the filter.

16. The HVAC system of claim 12, wherein the first panel, the second panel, and the third panel each have a bottom bracket, wherein each of the bottom brackets has a triangular shape.

17. The HVAC system of claim 16, wherein a filter is configured to be received between the top brackets and the bottom brackets of the U-shaped frame.

18. The HVAC filter assembly of claim 12, wherein an angled surface of the top brackets is configured to secure a light emitting diode (LED) array.

19. A method for determining an optimal placement of a light emitting diode (LED) array, the method comprising:
simulating a particle to traverse an illuminated space;
capturing an intensity at each point in a trajectory of the particle;
estimate a total exposure dose by integrating the intensity along the trajectory;
comparing the estimated total exposure dose to a target disinfection dose; and
creating a two-dimensional (2D) map of a total dose at each point across a duct of an HVAC system, the duct configured to receive an HVAC filter assembly.

20. The method of claim 19, wherein the HVAC filter assembly includes:
an access assembly; and
a filter frame guidance assembly secured to the access assembly, the filter frame guidance assembly including a U-shaped frame having a first panel with a top bracket, a second panel with a top bracket, and a third panel with a top bracket.
